(19) United States
(12) Patent Application Publication
(10) Pub. No.: US 2007/0258556 A1
(43) Pub. Date: Nov. 8, 2007

(54) Annular nuclear fuel rod controllable in heat fluxes of inner and outer tubes

(75) Inventors: Kun Woo Song, Yuseong-ku (KR); Tae Hyun Chun, Yuseong-ku (KR); Yong Sik Yang, Yuseong-ku (KR); Je Geon Bang, Yuseong-ku (KR); Dong Seok Oh, Yuseong-ku (KR)

Correspondence Address: MCDERMOTT WILL & EMERY LLP, 18191 VON KARMAN AVE., SUITE 500, IRVINE, CA, 92612-7108, US

(73) Assignees: KOREA ATOMIC ENERGY RESEARCH INSTITUTE; KOREA HYDRO & NUCLEAR POWER CO., LTD.

(21) Appl. No.: 11/606,104

(22) Filed: Nov. 30, 2006

(30) Foreign Application Priority Data
Mar. 15, 2006 (KR) 10-2006-0024120

(51) Int. Cl. G21C 3/00

(52) U.S. Cl. 376/455

(57) ABSTRACT

The invention relates to an annular nuclear fuel rod. The annular fuel rod includes an outer tube; an inner tube having a diameter smaller than that of the outer tube, and arranged coaxially with the outer tube; a plurality of inner annular pellets loaded between the outer and inner tubes, adjacent to the inner tube; a plurality of outer annular pellets loaded between the outer and inner tubes, adjacent to the outer tube. Preferably, the inner annular pellets are spaced from the outer annular pellets with an intermediate gap. The annular nuclear fuel rod can remove unbalanced heat flux between inner and outer tubes, and furthermore, control the heat flux between the inner and outer tubes.

### CLAIM OF PRIORITY

This application claims the benefit of Korean Patent Application No. 2006-24120 filed on Mar. 15, 2006, in the Korean Intellectual Property Office, the disclosure of which is incorporated herein by reference.

### BACKGROUND OF THE INVENTION

1. Field of the Invention

The present invention relates to an annular nuclear fuel rod including inner and outer tubes, in particular, in which inner and outer annular pellets are loaded in combination so that the heat fluxes of the inner and outer tubes can be controlled.

2. Description of the Related Art

FIG. 1a is a cross-sectional view of a conventional cylindrical nuclear fuel rod, and FIG. 1b is a perspective view of a pellet used in the cylindrical nuclear fuel rod.

The cylindrical nuclear fuel rod includes a zirconium (Zr) alloy tube 1 and pellets 2 spaced from the tube 1 with a gap 3. To be specific, the tube 1 is sealed at both ends, in which several hundreds of the cylindrical pellets 2 are loaded inside the tube 1 and pressed by springs. In general, each pellet 2 has a diameter of about 9 mm and a length of about 10 mm, and the nuclear fuel rod has a diameter of about 10 mm and a length of about 4 m. About 3.6 m of the total length of the nuclear fuel rod is used for loading the pellets 2 with the remaining length used for the springs.

The pellet 2 is made of a ceramic containing a nuclear fissionable material such as Uranium (U) and Plutonium (Pu), by compression molding and hot sintering of nuclear fissionable material powder.

During the burning of the nuclear fuel rod, the heat generated from the pellet 2 is transferred through a gap 3 and the tube 1 to coolant. The coolant flows along the exterior of the nuclear fuel rod while contacting the tube 1.

The performance of the conventional cylindrical nuclear fuel rod like this is restricted in terms of temperature and heat flux. To be specific, the pellets 2 have a low thermal conductivity so that heat generated through nuclear fission is not delivered quickly to the coolant. As a result, the temperature of pellets 2 is much higher than that of coolant. The temperature of the coolant is in the range from 320° C. to 340° C., and the pellet temperature is highest in the center and lowest on the surface. During normal nuclear fission of the nuclear fuel rod, the pellets 2 have a central temperature in the range between 1,000° C. and 1,500° C. Since the pellets have a high temperature, all reactions dependent on temperature are accelerated and material performance is degraded. In particular, performance degradation becomes more severe in proportion to the burn-up of nuclear fuel. In addition, in several nuclear accidents, the margin of safety is reduced when the temperature of pellets 2 is high. For example, in case of Loss of Coolant Accident (LOCA), the margin becomes smaller as the nuclear fuel has a higher temperature just before the accident. Accordingly, the nuclear fuel is designed so that the temperature of the nuclear fuel rod does not exceed a limit. Thus its safety is enhanced if the pellet temperature is low.

The nuclear fuel rod, when having a higher heat flux, may experience a departure from nucleate boiling. In case of the departure from nucleate boiling, a bubble film is built up on the surface of the tube 1, which severely deteriorates heat transfer from fuel rod to coolant, thereby damaging the nuclear fuel rod. As a result, the nuclear fuel rod is designed not to experience any departure from nucleate boiling. Its safety is further enhanced at a lower heat flux.

To overcome such limitations associated with the temperature and heat flux of the conventional cylindrical nuclear fuel rod, an approach was proposed in U.S. Pat. No. 3,928,132 to Roko Bujas, titled “Annular fuel element for high temperature reactor,” 1975. As disclosed in this document, a nuclear fuel rod has an annular shape so that coolant flows along both of the exterior and interior of the nuclear fuel rod.

FIG. 2a is a cross-sectional view of such a conventional annular nuclear fuel rod, and FIG. 2b is a perspective view of a pellet used in the annular nuclear fuel rod shown in FIG. 2a.

The conventional annular nuclear fuel rod includes an inner tube 11 and an outer tube 12 spaced from the inner tube 11 so that annular pellets 20 are loaded between the tubes 11 and 12. That is, the annular pellets 20 are surrounded by the inner and outer tubes 11 and 12. The tubes 11 and 12 are welded at both ends to seal the annular pellets 20 which are pressed by springs. Coolant flows through an inner space inside the inner tube 11 and an outer space outside the outer tube 12.

In this structure, the coolant additionally flows through the hottest central portion of the annular nuclear fuel rod, dropping the temperature of the nuclear fuel rod significantly. This also greatly increases heat transfer area per nuclear fuel rod, thereby decreasing heat flux. As a result, rise in thermal margin is expectable.

However, heat generated from the annular pellets 20 of the conventional annular nuclear fuel rod is transferred to the coolant through both the inner and outer tubes 11 and 12. If more heat flows through one of the tubes 11 and 12, then less heat flows through the other one. This is associated with the thermal resistances in the directions of the tubes 11 and 12, that is, more heat is distributed to a tube in a direction of less thermal resistance. This as a result causes a problem in that the heat flux of one tube becomes much higher than that of the other tube.

Thermal resistance in the conventional annular nuclear fuel rod will be explained in detail as follows.

As shown in FIG. 2a, the annular nuclear fuel rod includes the inner tube 11, an inner gap 31, the annular pellets 20, an outer gap 33 and the outer tube 12, in which inner coolant is provided inside the inner tube 11 and outer coolant is provided outside the outer tube 12. The thermal resistance existing in the annular nuclear fuel rod may be classified into three types of thermal resistances: an intrinsic thermal resistance that the pellets have; thermal resistances that the gaps between the pellets and the tubes have; and intrinsic thermal resistances that the tubes have. Of these three types of thermal resistances, those of the pellets and tubes are thermal properties and thus rarely changeable while the nuclear fuel rod is burning in a reactor. On the other hand, the thermal resistances of the gaps are proportional to the dimension of the gaps and thus affected by the variation of the inner and/our outer gaps 31 and 33 while the annular nuclear fuel rod is burning in the reactor.

In the nuclear fuel rod assembled together, the gap 31 between the annular pellets 20 and the tube 11 and the gap 32 between the annular pellets 20 and the tube 12 are typically in the range from 50 μm to 100 μm. The gaps 31 and 33 are designed to be as small as possible to reduce thermal resistance. During the burning of the annular nuclear fuel rod, the inside and outside diameters of the annular pellets 20 are increased owing to thermal expansion. In addition, the annular pellets 20 swell with the burning going on, thereby gradually increasing the outside diameter thereof. Accordingly, the inner gap 31 is increased by the variation in the dimensions of the pellets 20 while the outer gap 33 is reduced. In the meantime, since the coolant applies a high pressure on the tubes, all of the inner and outer tubes 11 and 12 are gradually deformed toward the annular pellets 20, thereby reducing the inner and outer gaps 31 and 13.

The pellets are subject to the heat expansion and swelling as described above in the case of ceramic materials, and the tubes are subject to deformation in the case of metallic materials. Therefore, the inner and outer gaps 31 and 33 of the annular nuclear fuel rod are changed irrespective of the type of the ceramic materials or of the tube metals.

During the burning of the conventional nuclear fuel rod in the nuclear reactor, the outer gap 33 becomes smaller than the inner gap 31 due to the thermal expansion at the initial stage, and as the burning time goes by, the outer gap 33 decreases further to be closed while the inner gap 31 remains open. Finally, the inner gap 31 comes to be closed.

The variation in the inner and outer gaps 31 and 33 greatly influences on thermal resistance. At an early stage of the burning, thermal resistance is lower in the direction of the outer tube 12 than in the direction of the inner tube 11. In particular, since the thermal resistance of the gap tends to decrease greatly when the gap is closed, in a case where the outer gap 33 is closed but the inner gap 31 remains open, the thermal resistance in the outward direction becomes much smaller than that in the inward direction.

Such changes in the thermal resistances increase the heat flux of the outer tube 12 but accordingly decrease the heat flux of the inner tube 11. In particular, in a case where the outer gap 33 is closed but the inner gap 31 remains open, the heat flux of the outer tube 12 becomes excessively higher than that of the inner tube 11. Accordingly, the conventional annular nuclear fuel rod has the same problem as the cylindrical nuclear fuel rod.

### SUMMARY OF THE INVENTION

The present invention has been made to solve the foregoing problems of the prior art and therefore an object of certain embodiments of the present invention is to provide an annular nuclear fuel rod which can remove unbalanced heat flux between inner and outer tubes, and furthermore, control the heat flux between the inner and outer tubes.

According to an aspect of the invention for realizing the object, there is provided an annular nuclear fuel rod. The annular fuel rod includes an outer tube; an inner tube having a diameter smaller than that of the outer tube, and arranged coaxially with the outer tube; a plurality of inner annular pellets loaded between the outer and inner tubes, adjacent to the inner tube; a plurality of outer annular pellets loaded between the outer and inner tubes, adjacent to the outer tube. Preferably, the inner annular pellets are spaced from the outer annular pellets with an intermediate gap.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a cross-sectional view of a conventional cylindrical nuclear fuel rod;

FIG. 1b is a perspective view of a pellet used in the cylindrical nuclear fuel rod shown in FIG. 1a;

FIG. 2a is a cross-sectional view of a conventional annular nuclear fuel rod;

FIG. 2b is a perspective view of a pellet used in the annular nuclear fuel rod shown in FIG. 2a;

FIG. 3a is a cross-sectional view of an annular nuclear fuel rod according to an embodiment of the invention;

FIG. 3b is a perspective view of a pellet used in the annular nuclear fuel rod shown in FIG. 3a; and

FIG. 4 is a schematic perspective view of an annular nuclear fuel rod according to another embodiment of the invention.

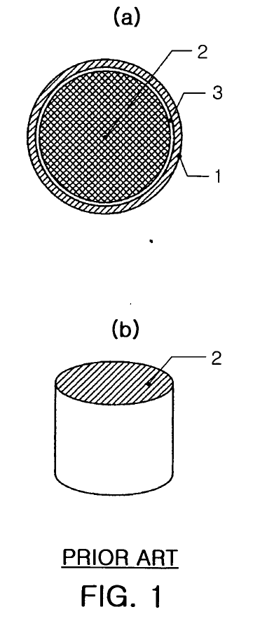

### DETAILED DESCRIPTION OF THE PREFERRED EMBODIMENT

The present invention will now be described more fully hereinafter with reference to the accompanying drawings, in which preferred embodiments of the invention are shown.

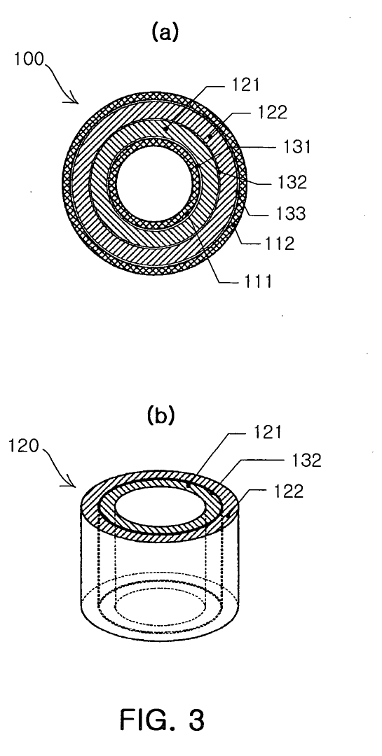

FIG. 3a is a cross-sectional view of an annular nuclear fuel rod 100 according to an embodiment of the invention, and FIG. 3b is a perspective view of annular pellets 120 used in the annular nuclear fuel rod 100.

The annular nuclear fuel rod 100 of this embodiment includes a plurality of the annular pellets 120 functioning as a nuclear fuel source and tubes 111 and 112 into which the annular pellets 120 are loaded. More particularly, the annular pellets 120 are composed of inner annular pellets 121 and outer annular pellets 122 having a diameter larger than that of the inner annular pellets 121. The tubes 111 and 112 are composed of an inner tube 111 and an outer tube 112 having a diameter larger than that of the inner tube 111. The inner annular pellets 121 are loaded adjacent to the inner tube 111, and the outer pellets 122 are loaded adjacent to the outer tube 112. The length of the annular nuclear fuel rod 100 is selected according to nuclear reactors, where the nuclear fuel rod 100 is used, and generally in the range from tens of centimeters to 4 meters.

In addition, the inner and outer tubes 111 and 112 are welded at both ends to seal the inner and outer annular pellets 121 and 122, in which coolant flows along the inner space of the inner tube 111 and the outer space of the outer tube 112 to cool the nuclear fuel rod.

The inner and outer tubes 111 and 112 have a structure that is not different from those of the conventional annular nuclear fuel rod, and they are generally made of a zirconium (Zr) alloy.

The inner annular pellets 121 and the outer annular pellets 122 are separately manufactured by using a ceramic containing a fissionable material such as uranium (U), plutonium (Pu) and thorium (Th). To be specific, powder of the fissionable material is compression-molded and hot-sintered into the pellets 121 and 122.

In the meantime, the inner annular pellets 121 are spaced radially from the outer annular pellets 122 with an intermediate gap 132, which functions as a thermal resistance blocking heat transfer between the inner and outer annular pellets 121 and 122. That is, the intermediate gap 132 functions to force the heat of the inner annular pellets 121 to flow toward the inner tube 111 and the heat of the outer annular pellets 122 to flow toward the outer tube 112.

In addition, an inner gap 131 is formed between the inner tube 111 and the inner annular pellets 121, and an outer gap 133 is formed between the outer annular pellets 122 and the outer tube 112.

Now, with reference to FIG. 3A, it will be described of a flow of heat through the inner tube 111, the inner gap 131, the inner annular pellets 121, the intermediate gap 132, the outer annular pellets 122, the outer gap 133, the outer pellets 112 and outer coolant.

In order for heat to be transferred, a temperature gradient overcoming thermal resistance is needed. Since large amounts of temperature gradients exist between the pellets and the tubes, heat can be transferred from the pellets to the tubes overcoming thermal resistance induced from the inner gap 131 and the outer gap 133. However, since the temperature gradient between the inner annular pellets 121 and the outer annular pellets 122 is very small, it is possible to effectively block the heat transfer between the inner and outer annular pellets 121 and 122 even if the intermediate gap 132 is designed to be smaller than the inner and outer gaps 131 and 133. Furthermore, by increasing the size of the intermediate gap 132, it is possible to further block the heat transfer between the inner annular pellets 121 and the outer annular pellets 122.

As a result, the heat generated from the inner annular pellets 121 is transferred to the inner tube 111 and the heat generated from the outer annular pellets 122 is transferred to the outer tube 112. Based on this principle, it is possible to control the heat fluxes of the inner tube 111 and the outer tube 112.

In the meantime, while the nuclear fuel rod is burning in the reactor, owing to thermal expansion as well as swelling, the outside diameter of the inner annular pellets 121 expands equally with the inside diameter of the outer annular pellets 122. Since the tubes are made of metal, the inner tube 111 is deformed toward the inner annular pellets 121 and the outer tube 112 is deformed toward the outer annular pellets 122, thereby reducing the inner and outer gaps 131 and 133. As a result, the intermediate gap 132 is rarely changed, and thus the thermal resistance of the intermediate gap 132 remains almost unchanged while the thermal resistance of the inner and outer gaps 131 and 133 is decreasing. Therefore, while the annular nuclear fuel rod 100 of this invention is burning in the reactor, it is possible to advantageously block the heat transfer between the inner annular pellets 121 and the outer annular pellets 122 with efficiency better than design.

The conventional nuclear fuel rod has a most serious problem associated with heat flux when the outer gap is closed but the inner gap remains open so that heat from the pellets excessively flows to the outer tube. However, in the nuclear fuel rod 100 of this invention, the intermediate gap 132 still maintains thermal resistance even in the absence of the outer gap 133. Since the thermal resistance of the intermediate gap 132 is larger than that of the inner gap 131, heat from the inner annular pellets 121 is not transferred to the outer annular pellets 122 but to the inner tube 111 through the inner gap 131. Based on this mechanism, it is possible to overcome the problem of the conventional nuclear fuel rod, that is, excessive heat flux in the outer tube.

In the annular nuclear fuel rod 100 of the invention, the size of the intermediate gap 132 is less limited in design than those of the inner and outer gaps 131 and 133. When the size of the central gap 132 is designed to be equal with as or larger than those of the inner and outer gaps 131 and 133, the heat transfer between the inner annular pellets 121 and the outer annular pellets 122 can be blocked sufficiently. In addition, when the size of the intermediate gap 132 is designed to be smaller than those of the inner and outer gaps 131 and 133, the heat transfer can also be blocked sufficiently since the temperature gradient across the intermediate gap 132 is sufficiently smaller than those across the inner and outer gaps 131 and 133.

However, the larger the intermediate gap size, the larger the loss of the volume of the pellets loaded into the nuclear fuel rod. This reduces heat generation per nuclear fuel rod, which is economically disadvantageous. Thus, it is advantageous to design the intermediate gap 132 as small as possible. Preferably, the size of the intermediate gap 132 is 500 μm or less.

In the annular nuclear fuel rod 100 of the invention, it is possible to control the heat fluxes of the inner and outer tubes 111 and 112, which will now be described in detail.

The heat fluxes of the inner and outer tubes 111 and 112 can be controlled since heat quantities generated from the inner and outer annular pellets 121 and 122 can be controlled, respectively. The inner and outer pellets 121 and 122 are made of a ceramic containing a fissionable material such as U, Pu and Th. When the inner annular and outer pellets 121 and 122 contain the same fissionable material at the same concentration, it is possible to control the amount of heat from the inner and outer pellets 121 and 122 by adjusting the weight or volume ratio of the inner annular pellets 121 to the outer annular pellets 122.

In addition, it is possible to control the amount of heat generated from the pellets by adjusting the fissionable material and its concentration contained in each pellet. That is, it is possible to produce more heat from a small volume by using more concentrated fissionable material, for example, more enriched U-235.

In the annular nuclear fuel rod 100 of the invention, the weight or volume ratio of the inner annular pellets 121 to the outer annular pellets 122 and the amount of the fissionable material are determined in consideration of heat generated from each pellet.

In the annular nuclear fuel rod 100 of the invention, the heat transfer area of the inner tube 111 is smaller than that of the outer tube 112. In order to keep the heat flux of the inner tube 111 the same as that of the outer tube 112, heat generated from the inner annular pellets 121 has to be smaller than that generated from the outer annular pellets 122. When the amount of heat generated from the inner annular pellets 121 is the same as that generated from the outer annular pellets 122, the heat flux of the inner tube 111 is higher than that of the outer tube 112 but this might be in an allowable range for the sake of safety. However, when the amount of heat generated from the inner annular pellets 121 is larger than that generated from the outer annular pellets 122, the heat flux of the inner tube 111 is excessively higher than that of the outer tube 112. This may cause a problem similar to that of the conventional annular nuclear fuel rod. Accordingly, it is preferred that the nuclear fuel rod is so designed that the heat of the inner annular pellets 121 does not that of the outer pellets 122, thereby balancing the heat flux of the inner tube 111 with the heat flux of the outer tube 112.

Describing it in more detail, the inner annular pellets 121 and the outer annular pellets 122 may be designed to have different volumes or the same volume. In addition, the inner annular pellets 121 and the outer annular pellets 122 may be designed to contain the same fissionable material with the same or different concentrations. Furthermore, different fissionable materials may be employed for the inner annular pellets 121 and for the outer annular pellets 122.

On the other hand, the lengths of the inner and outer annular pellets 121 and 122 do not affect heat transfer and thus do not have design limitations. The lengths may be in the range from several millimeters to tens of centimeters according to fabrication processes.

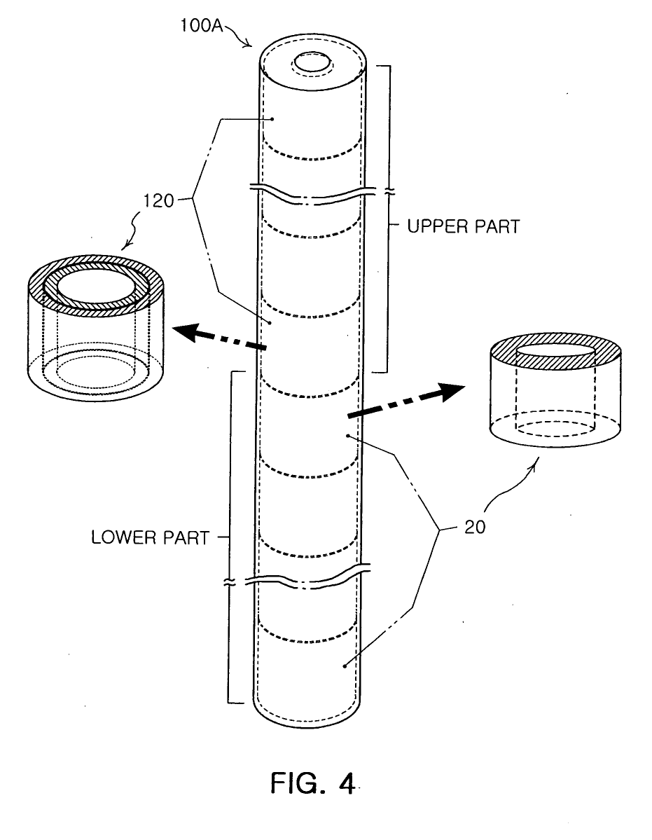

Now description will be given of an annular nuclear fuel rod 100A according to another embodiment of the invention with reference to FIG. 4.

FIG. 4 is a schematic perspective view of the annular nuclear fuel rod 100A according to this embodiment.

The annular nuclear fuel rod 100A of this embodiment is the same as the annular nuclear fuel rod 100 of the foregoing embodiment except that two different types of annular pellets are loaded into the nuclear fuel rod 100A. Accordingly, description on the same components will be omitted.

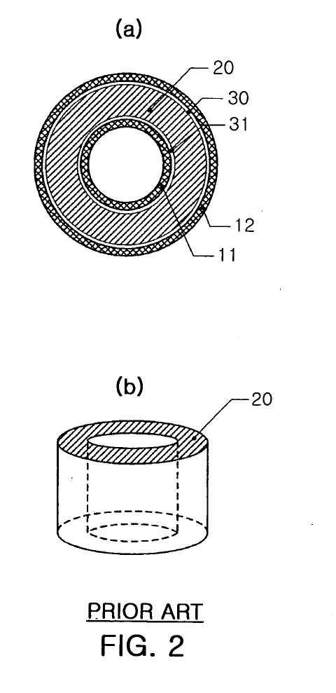

In detail, the nuclear fuel rod 100A has a plurality of annular pellet combinations of inner and outer annular pellets 121 and 122 loaded in a partial space and a plurality of unitary annular pellets 20 (see FIG. 2b) loaded in the remaining space. That is, two types of pellets are loaded in the single annular nuclear fuel rod 100A. Each of the unitary annular pellets 20 is of one body structure which is not divided into the inner annular pellet 121 and the outer annular pellet 122.

Generally in the annular nuclear fuel rod, heat flux is troublesome particularly in an upper part of the nuclear fuel rod where coolant has a relatively higher temperature. Therefore, it is economically advantageous that the combinations of the inner and outer annular pellets 121 and 122 are loaded in an upper space of the annular nuclear fuel rod 100A and the unitary annular pellets 20 are loaded in a lower space of the annular nuclear fuel rod 100A. This is because that the intermediate gap in the annular nuclear fuel rod may decrease the volume of fissionable material, thereby dropping the amount of heat per nuclear fuel rod. Furthermore, the combined annular pellets including the inner and outer annular pellets 121 and 122 are more expensive to fabricate than the unitary annular pellets 20.

As set forth above, the annular fuel rod of the invention incorporating a combined structure of inner and outer annular pellets can overcome unbalanced heat flux of a conventional annular fuel rod. Furthermore, by adjusting the volume ratio of the outer annular pellets to the inner annular pellets or the fissionable material and its concentration, it is possible to control the heat fluxes of the inner and outer tubes. As a result, there is an effect of enhancing the safety of the nuclear fuel rod.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

1. An annular nuclear fuel rod comprising:
an outer tube;
an inner tube having a diameter smaller than that of the outer tube, and arranged coaxially with the outer tube;
a plurality of inner annular pellets loaded between the outer and inner tubes, adjacent to the inner tube;
a plurality of outer annular pellets loaded between the outer and inner tubes; adjacent to the outer tube,
wherein the inner annular pellets are spaced from the outer annular pellets with an intermediate gap.

2. The annular nuclear fuel rod according to claim 1, wherein the inner annular pellets are made of ceramic fissionable materials comprising uranium.

3. The annular nuclear fuel rod according to claim 1, wherein the outer annular pellets are made of ceramic fissionable materials comprising uranium.

4. The annular nuclear fuel rod according to claim 1, wherein the inner and outer tubes are controlled in heat flux by selection of weight ratio or volume ratio between the outer annular pellets and the inner annular pellets.

5. The annular nuclear fuel rod according to claim 1, wherein the inner and out tubes are adjusted in heat flux by selection of types and concentrations of a fissionable material contained in the outer annular pellets and the inner annular pellets.

6. The annular nuclear fuel rod according to claim 1, wherein the intermediate gap is up to 500 μm.

7. The annular nuclear fuel rod according to claim 1, wherein heat generated from the inner annular pellets is less than that generated from the outer annular pellets.

8. The annular nuclear fuel rod according to claim 1, wherein the inner annular pellets and the outer annular pellets contain an identical fissionable material.

9. The annular nuclear fuel rod according to claim 1, wherein the inner annular pellets and the outer annular pellets contain different fissionable materials.

10. The annular nuclear fuel rod according to claim 1, wherein the inner annular pellets and the outer annular pellets are loaded in the whole space between the inner and outer tubes, thereby forming combined annular pellets.

11. The annular nuclear fuel rod according to claim 1, wherein a plurality of the inner annular pellets and the outer annular pellets are loaded in a partial space of annular nuclear fuel rod, thereby forming combined annular pellets,
said fuel rod further comprising: a plurality of unitary annular pellets loaded in the remaining space of annular nuclear fuel rod, each of the unitary annular pellets not divided into the inner and outer pellets.

12. The annular nuclear fuel rod according to claim 11, wherein the partial space where the combined annular pellets are loaded has a higher coolant temperature than the remaining space where the unitary annular pellets are loaded.
